(19) United States
(12) Patent Application Publication
(10) Pub. No.: US 2015/0146201 A1
(43) Pub. Date: May 28, 2015

(54) OPTICAL PROBE WITH EXTENDED WORKING DISTANCE

(71) Applicants: Michael Burka, Winchester, MA (US); Stephen McLaughlin, Andover, MA (US); Malcolm C. Smith, Winchester, MA (US); Jie Zhang, Hockessin, DE (US)

(72) Inventors: Michael Burka, Winchester, MA (US); Stephen McLaughlin, Andover, MA (US); Malcolm C. Smith, Winchester, MA (US); Jie Zhang, Hockessin, DE (US)

(21) Appl. No.: 13/875,671

(22) Filed: May 2, 2013

(51) Int. Cl. G01J 3/02; G01J 3/44

(52) U.S. Cl. CPC G01J 3/0218; G01J 3/44
USPC 356/301

(57) ABSTRACT

A side-looking optical probe for a Raman spectroscopy system is provided. The probe includes: a base for mounting the probe to an optical assembly of the system; and a prism mounted to the base, the prism configured for receiving signal light from a sample and providing the signal light to the system. A method of fabrication and a spectrometer are provided.

### STATEMENT REGARDING FEDERALLY SPONSORED RESEARCH

This invention was made with government support under N0178-04-D-4143-FG01 awarded by U. S. Navy, NAVEODTECHDIV. The government has certain rights in the invention.

### BACKGROUND OF THE INVENTION

1. Field of the Invention

The invention disclosed herein relates to a Raman spectroscopy system, and in particular to optics for a Raman spectroscopy system.

2. Description of the Related Art

Raman spectroscopy systems provide versatile field-use instruments for chemical identification. The capabilities provided are extremely valuable for law enforcement, military personnel, hazmat personnel, environmental surveillance and in many other settings. By making use of Raman spectroscopy systems, personnel are able to obtain accurate chemical identification in seconds, even through sealed translucent containers.

With conventional Raman spectroscopy systems, a sample must be within a few millimeters of the instrument. In some embodiments, this means that the sample must be placed very close to or against a window of the instrument. In some other embodiments, the Raman spectroscopy system includes a fiber optic probe. The flexible probe can be adjusted so that the probe end is within a few millimeters of the sample. Generally, it is preferable to use a fiber optic probe in order to minimize contact with potentially hazardous samples sample and thus eliminate the need to move the sample to a position where it is more easily measured.

However, whether using a system that includes a window or a probe, a measuring portion of the system must always be placed very close to the sample. This generally means that a user must orient each sample for analysis. This can be a time-consuming and dangerous task.

Conventional forward-looking probes on Raman spectroscopy systems are designed to probe samples that are placed in front of the probe head, collinear with a distal section of the probe. However, in some situations, it is desirable to have a side-looking probe. For example, if one has to snake the probe between two closely spaced containers while interrogating the contents of one of them or if one wishes to interrogate a sample that is on a surface at a distance nearly equal to the probe length. In the first of these instances, it is important for the transverse profile of the probe to remain small. Simply porting the objective lenses from front to side would result in a probe head too bulky to be easily used. Moreover, one wants to retain the option of using the probe in a forward-looking configuration in addition to the side-looking configuration. So, a means of easily switching the probe head from one configuration to the other is required to accommodate this option.

An obvious method for creating a side-looking probe is an attachment with a flat minor situated at a 45 degree angle to the exiting beam. The disadvantage of this method is that it leaves a very small effective working distance beyond the probe's outer extent. For example, in one embodiment, the back focal length of the objective lens is 15.5 mm and the outer diameter of the probe head is 16.1 mm. Accordingly, in this embodiment, the maximum working distance beyond the probe head edge while maintaining the full clear aperture for maximum collection efficiency is 15.5−6.35−8.05=1.1 mm.

One might argue that simply increasing the objective focal length would overcome the disadvantage of short working length. However, that solution is disfavored due to increased eye safety hazard and loss of optical collection efficiency.

Thus, what are needed are methods and apparatus to enhance an optical interface of a Raman spectroscopy system. Preferably, the methods and apparatus provide for a side-looking capability, are cost effective to manufacture and use, and provide for an increased working distance.

### SUMMARY OF THE INVENTION

In one embodiment, a side-looking optical probe for a Raman spectroscopy system is provided. The probe includes: a base for mounting the probe to an optical assembly of the system; and a prism mounted to the base, the prism configured for receiving signal light from a sample and providing the signal light to the system.

In another embodiment, a method for fabricating a side-looking optical probe for a Raman spectroscopy system is provided. The method includes: selecting a base for mounting the probe to an optical assembly of the system; and mounting a prism to the base, the prism configured for receiving signal light from a sample and providing the signal light to the system.

In yet another embodiment, a Raman spectroscopy system is provided. The system includes: a Raman spectrometer that includes a laser light source and a signal analyzer, the light source configured for illuminating a sample and the analyzer configured for analyzing signal light; a fiber optic assembly configured for receiving light from the light source and receiving signal light from a sample; and a side-looking probe optically mounted to the fiber optic assembly, the side-looking probe comprising a prism configured for receiving signal light from the sample and providing the signal light to the spectrometer.

In a further embodiment, a method of using a Raman spectroscopy system is provided. The method includes: selecting a Raman spectroscopy system that includes a side-looking probe, the probe including a prism mounted to a fiber optic assembly, the prism configured for receiving signal light from a sample and providing the signal light to the system; and analyzing a sample with the system.

### BRIEF DESCRIPTION OF THE DRAWINGS

The features and advantages of the invention are apparent from the following description taken in conjunction with the accompanying drawings in which:

FIG. 1 is a schematic illustration of an embodiment of a Raman spectroscopy system;

FIG. 2 is a diagrammatic perspective view of a probe head portion of a fiber optic assembly of FIG. 1;

FIG. 3 is a side elevational of the probe head portion of FIG. 2;

FIG. 4 is a schematic illustration of a further portion of the spectrometry assembly of FIG. 1;

FIG. 5 is a schematic illustration of an alternative embodiment of the probe head portion;

FIGS. 6A-6C, collectively referred to herein as FIG. 6, are perspective views of a side-looking attachment for the probe head;

FIG. 7 is a schematic illustration relating a sample to the probe head for the side-looking attachment;

FIG. 8 depicts an embodiment of optical elements for an embodiment of the Raman spectroscopy system that includes the side-looking attachment;

FIGS. 9A-9B, collectively referred to herein as FIG. 9, are comparative schematic views of optical arrangements for the side-looking probe. FIG. 9A depicts a prior art embodiment using a minor; FIG. 9B depicts an embodiment of the side-looking probe using a prism as disclosed herein; and

FIG. 10 is a graphic depicting geometric references used for estimating working distance.

### DETAILED DESCRIPTION OF THE INVENTION

Disclosed herein are methods and apparatus for performing Raman spectroscopy with a side-looking instrument. Generally, the side-looking instrument disclosed herein may be used with a variety of Raman spectroscopy systems. Advantageously, the side-looking instrument provides for side-looking sampling with a conventional optical probe, and further provides for extension of the working distance and therefore increased versatility. In order to provide some context, aspects of an exemplary and non-limiting embodiment of a Raman spectroscopy system are now introduced.

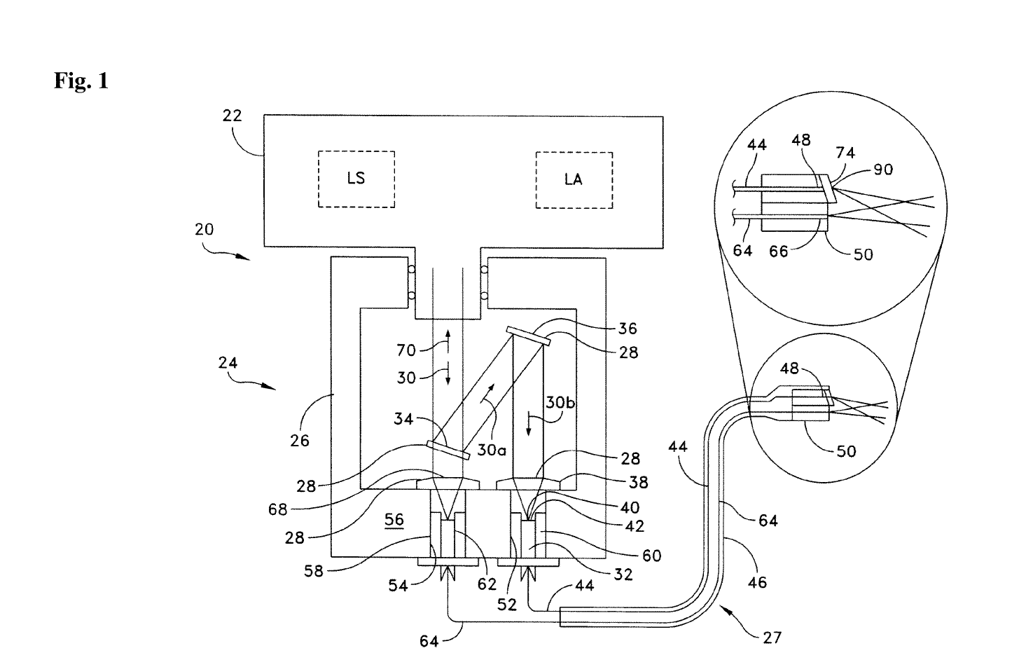

Referring to FIG. 1, it will be seen that an illustrative embodiment of a Raman spectroscopy assembly 20 includes a Raman spectrometer 22 including a laser light source LS and a light analyzer LA.

The assembly 20 further includes an interface module 24 that includes a housing 26 which is connectable to, and disconnectable from, the spectrometer 22, and a fiber optic assembly 27 which is connectable to, and disconnectable from, the interface module 24.

Mounted in the housing 26 are light manipulating devices 28 arranged so as to receive laser light 30 from the spectrometer 22 and direct the laser light, finely focused, to a first ferrule 32 of the fiber optic assembly 27. The light manipulating devices 28 are further arranged to receive Raman signal light and direct the Raman signal light to the light analyzer LA of the spectrometer 22.

In the embodiment shown in FIG. 1, the particular light manipulating devices 28 include a notch filter 34 which directs laser light 30a toward a reflector 36 which directs the laser light 30b through a focusing lens 38 which focuses the light 30b onto a fine point 40 on an inner end 42 of the ferrule 32.

In the fiber optic assembly 27, ferrule 32 has fixed thereto a flexible excitation fiber 44 housed in a flexible protective shielding 46. A distal end 48 of the laser fiber 44 is held in a probe head 50.

The housing 26 is provided with two openings 52, 54 extending through a wall 56 thereof. Flanged sleeves 60, 58 are fixed in openings 52, 54, respectively. The ferrule 32 of the fiber optic assembly 27 is insertable into, and removable from the fixed sleeve 60 of the housing 26. Similarly, a second ferrule 62 of the fiber optic assembly 27 is insertable into, and removable from, the fixed sleeve 58 of the housing 26.

The ferrule 62 has fixed thereto a collection fiber 64 which is housed in the protective shielding 46, alongside the excitation fiber 44. A distal end 66 of the collection fiber 64 is held in the probe head 50.

A collimating lens 68 is aligned with the collection fiber ferrule 62 and directs Raman signal light 70 through the notch filter 34 and into the spectrometer 22, and in particular the light analyzer LA.

While a specific arrangement of light manipulating devices 28 has been shown and described, it will be apparent that any suitable arrangement of light manipulating devices could be used to direct excitation laser light therethrough to the excitation fiber and to receive Raman signal light by way of the collection fiber 64 and direct the Raman signal light to the light analyzer of the spectrometer.

If, in use, any part of the fiber optic assembly 27, such as the probe head 50 and/or protective shielding 46 becomes contaminated, the ferrules 32, 62 may simply be “unplugged” from the sleeves 60, 58, and replaced with another optical fiber assembly, including a new probe head.

Both the fiber optic assembly, and the interface module can be readily removed from the spectrometer 22. Any selected releasable mechanical connection apparatus may be used to attach the interface module to the spectrometer 22, including snap-on, clamp-on, screw-on, slide-and-lock-on arrangements, and the like.

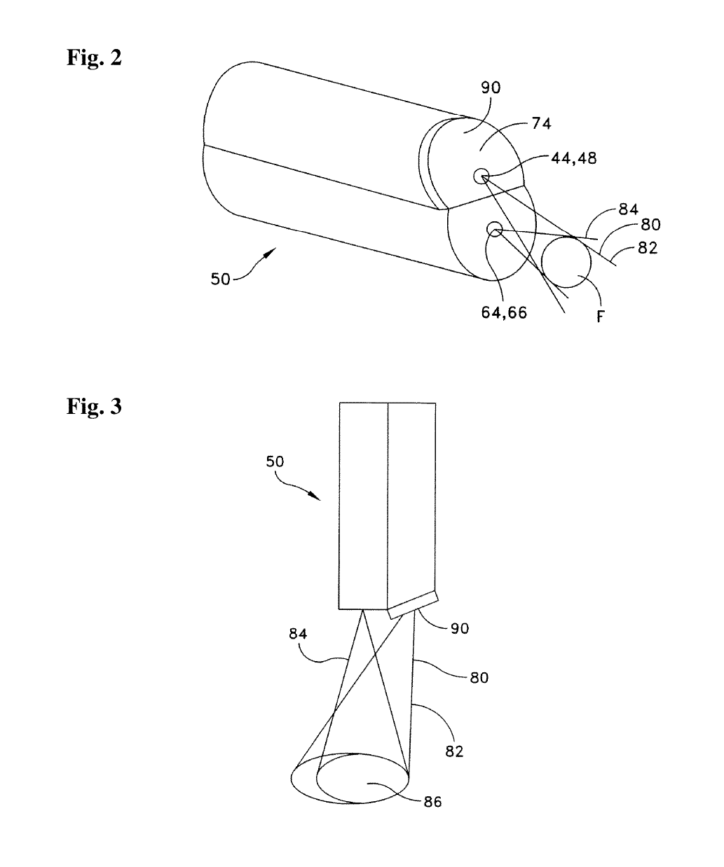

Referring to FIGS. 2 and 3, it will be seen that the probe head 50 may be shaped such that the geometry of the area of the specimen S which is impacted can be predetermined. As shown in FIGS. 1 and 2, an end facet 74 of the excitation fiber 44 can be at an angle to the end 66 of the collection fiber 64.

As shown in FIGS. 2 and 3, the laser light 80 emitted from the distal end 48 of the excitation fiber 44 is in a conical configuration 82. Light reflected from the specimen S, that is, the Raman signal light 70, travels back in a cone-shaped path 84 towards the distal end 66 of the collection fiber 64 and also disperses outwardly from the path 84 and is lost. The amount of collected Raman signal depends in large measure on the geometry of the design of the probe head 50 and particularly on the cone overlap area 86 effected by the two fibers 44, 64.

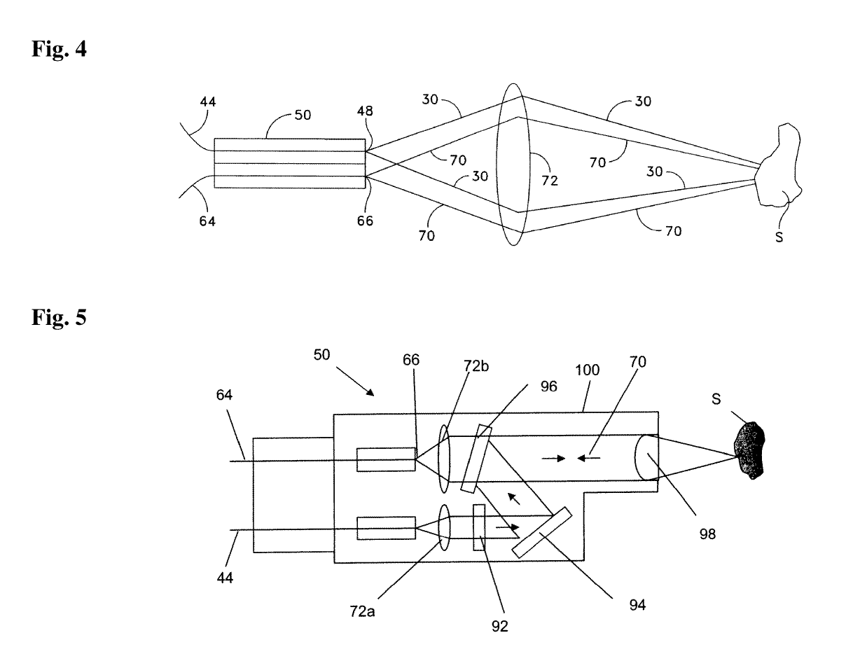

Referring to FIG. 4, it will be seen that the fiber optic assembly may include a lens 72 disposed adjacent the probe head distally of the distal ends of the excitation fiber 44 and the collection fiber 64. Alternatively, the lens 72 may be used as a separate component spaced from the probe head 50. Emerging from the distal end 48 of the excitation fiber 44, the laser light 30 diverges. The lens 72 focuses the light 30 on a small area of the specimen S under test. The reflected Raman signature light 70 similarly diverges, but is focused by the lens 72 onto the distal end 66 of the collection fiber 64. Thus, relatively little Raman signal is lost compared to the extensive loss realized in the arrangement shown in FIG. 2.

Referring again to FIGS. 1-3, it will be seen that the distal end 48 of the excitation fiber 44 may be covered with a thin fiber band pass filter 90 which transmits only laser light and rejects Raman signals which may be generated by the excitation fiber. Thus, the Raman signal light 70 includes substantially only Raman signal from the specimen S and essentially none from the excitation fiber.

Referring to FIG. 5, it will be seen that in an alternative embodiment, the fiber optic assembly probe head 50 includes first and second lenses 72a and 72b aligned distally of distal ends of the optical fibers 44, 64, the first 72a of the lenses being adapted to intercept diverging laser light emanating from the excitation fiber 44 and collimate the laser, and the second 72b of the lenses being adapted to intercept a Raman signal light 70 reflected from the specimen S and focus the Raman signal light onto the distal end 66 of the collection fiber 64. A band pass filter 92 is adapted to suppress Raman signal generated by the excitation fiber material and prevent such signal from reaching the specimen. A reflector 94 redirects the filtered laser light to a notch filter 96. The notch filter 96 is disposed in the probe head and is adapted to transmit Raman signal light emanating from the specimen and to block laser light reflected back from the specimen from reaching the distal end 66 of the collection fiber 64. A focusing lens 98 is disposed at the distal end of the probe head 50, the focusing lens 98 being adapted to focus the laser light on a reduced area of the specimen S, and further adapted to collect Raman signal light generated and reflected from the sample, and direct the reflected light toward the distal end 66 of the collection fiber 64. A water-sealed enclosure 100, made of a selected one of metal, plastic, ceramic material and any chemically inert material, serves to house components of the probe head 50.

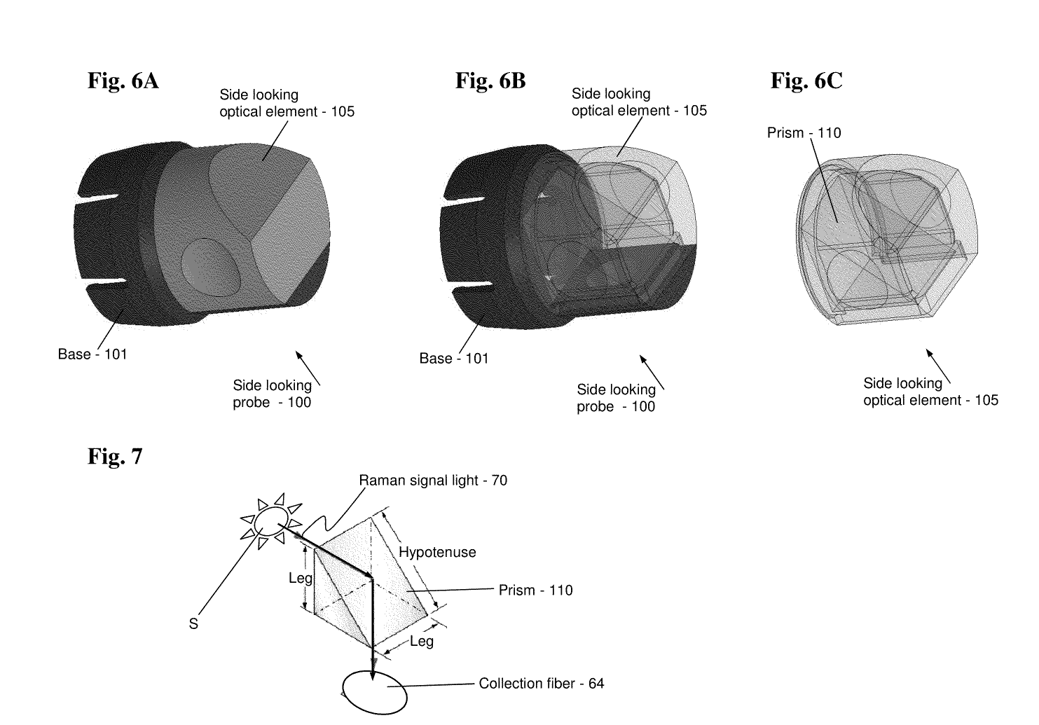

Referring to FIGS. 6A-6C, collectively referred to herein as FIG. 6, there is shown a side-looking probe 100. The side-looking probe 100 may be placed over a distal end of the fiber optic assembly 27. Generally, the side-looking probe 100 includes a base 101 and a side-looking optical element 105. The side-looking probe 100 may be configured for cooperation with a certain configuration of the fiber-optic assembly 27, such as with a specific embodiment of the assembly probe head 50, or in place of the forward-looking assembly probe head 50.

Generally, the base 101 is configured for robust mechanical engagement with the fiber optic assembly 27, such as by clamping upon flexible protective shielding 46. In some embodiments, the base 101 is configured with one of a snap-on, clamp-on, screw-on, slide-and-lock-on arrangement for mating with the fiber-optic assembly 27.

The base 101 provides for optical alignment of the side-looking optical element 105 with the excitation fiber 44 and the collection fiber 64. Contained within the side-looking optical element 105 is a prism 110. In some embodiments, the prism 110 is a right angle prism 110. The side-looking optical element 105 may include additional components, such as at least one additional lens.

Referring to FIG. 7, when in use, Raman signal light 70 emitted by the sample, S, is reflected from an interior hypotenuse of the prism 110 into the collection fiber 64.

By inserting the prism 110 with one face is normal to the collimating lens 68 and one face normal to the sample, S, a working distance is extended by an amount equal to d(1−1/n), where d represents the length of one leg of the prism 110 and n represents the refractive index of material used in the prism 110. For example, in one embodiment, a prism 110 formed of a material having a refractive index, n, of about 1.5 was used. The prism 110 had a leg length of about 10 mm, resulting in a working distance increase from 1.1 mm to 4.4 mm, which is substantially easier to work with.

In some embodiments, the base 101 is configured with a mounting system that is common with the forward-looking assembly probe head 50. Thus, one can easily and rapidly switch between forward-looking and side-looking configurations by removing or replacing the side-looking probe 100.

The side-looking probe 100 may be used with or without a protective window, such as the sapphire window. Advantageously, a vial holder can be configured to work with the side-looking probe 100, which is something that could not be done with a simple planar reflecting minor. One can, if one chooses, seal the side-looking probe 100 so that the face of the prism 110 that is normal to the sample, S, serves the function of a sapphire window. The prism 110 may be provided with a hard coat to improve scratch resistance. The prism 110 may be manufactured from a sapphire substrate, and may include polarization compensation in the optical design.

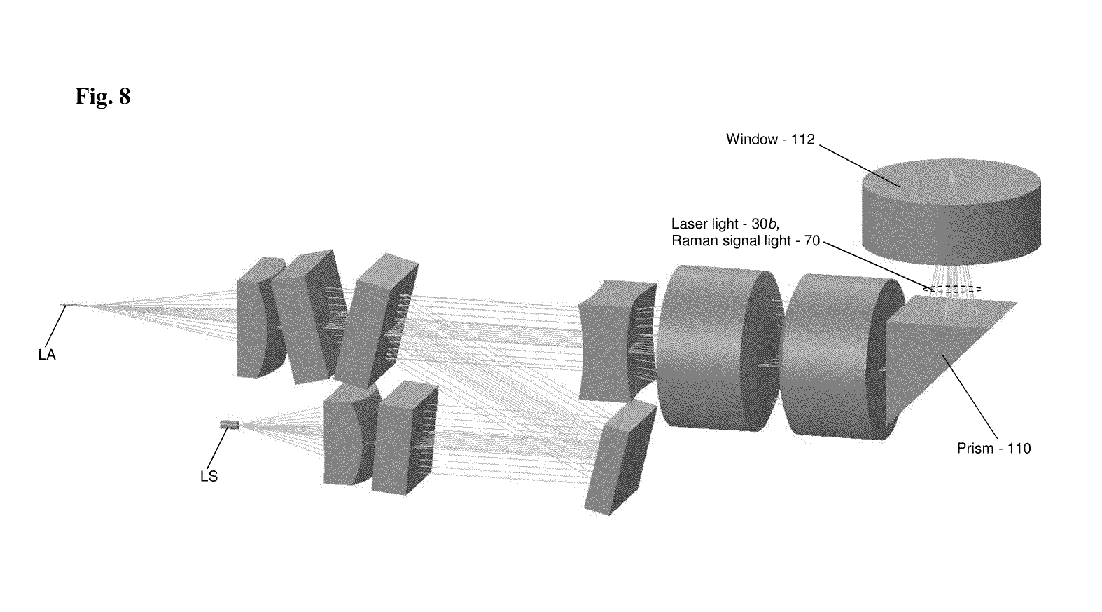

Referring to FIG. 8, a schematic representation of optical elements and light paths within the spectrometer 22 is provided. In this example, the laser light 30b and the Raman signal light 70 enter the prism 110. The laser light 30b is directed from the prism 110 into window 112 to illuminate the sample, S. The Raman signal light 70 emitted from the sample, S, enters window 112, then prism 110, which then directs the Raman signal light 70 into the interface module 24.

Having introduced embodiments of the side-looking probe 100 some additional aspects are now presented.

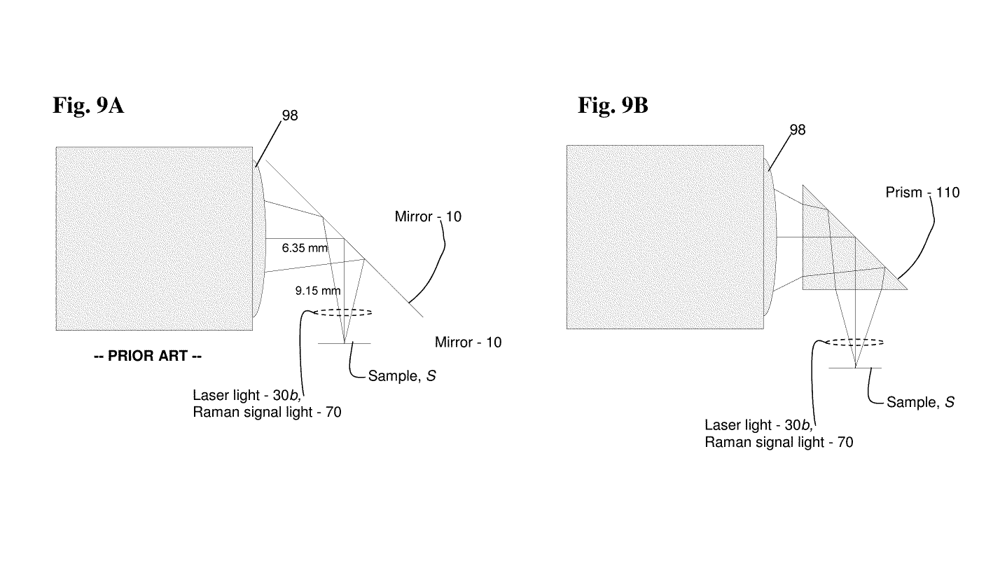

Referring now to FIG. 9, more detail regarding improvements in the working distance that is realized by use of the prism 110 is provided.

First, with reference to FIG. 9A, estimation of the working distance with an embodiment of a prior art side-looking probe is presented. The prior art side-looking probe makes use of a minor to provide reflection. In this embodiment, with a lens diameter of 12.7 mm and a 45 degree fold mirror, the closest distance of the reflection point to the lens is 12.7/2=6.35 mm.

The focus distance is 15.5 mm from the lens. The first 6.35 mm are to the reflection point. That leaves 9.15 mm in the perpendicular direction from the center of the lens to the focus point. The probe head that contains the lens is 16.1 mm in diameter, or 8.05 mm in radius. So, the focus point is 9.15−8.05=1.1 mm beyond the outer diameter of the probe head.

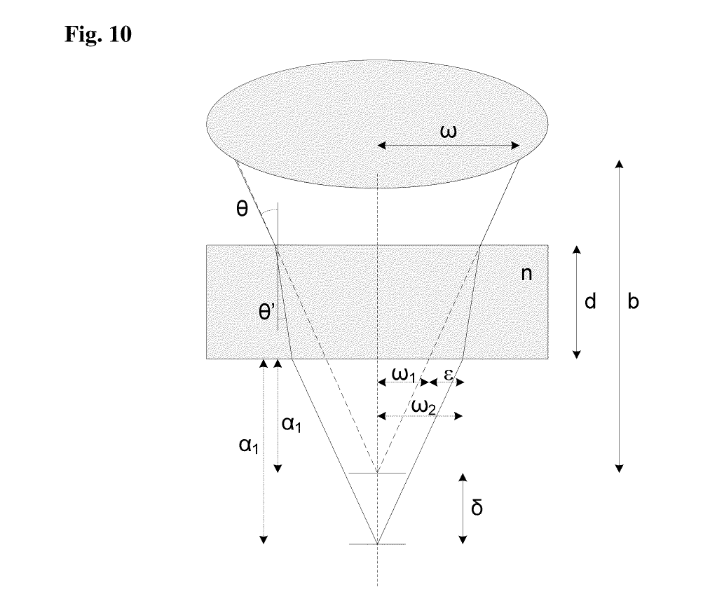

As may be seen with reference to FIG. 9B, the working distance is greatly improved with use of the prism 110. By using a prism in place of the mirror, the physical distance to the sample position is increased because the optical path difference within the prism is equal to the physical path length multiplied by the refractive index of the prism. The optical path is illustrated in FIG. 9B, and better explained with regards to FIG. 10 below.

Referring now also to FIG. 10, derivation of the working distance for a side-looking probe that makes use of a prism is provided. To calculate the difference in working distance when using a prism in place of a fold minor, it is easiest to “unfold” the optical path. In this case, the length, d, is equal to the distance the central ray travels through the prism made of material with refractive index, n. The distance from the lens to the focus position without the prism is b, and the additional working distance gained through use of the prism is δ.

The calculation of δ is as follows:

θ=tan−1 (ω/b) Convergence angle of the light cone coming out of the lens;

θ′=sin−1 ((1/n)sin(θ)) Smaller convergence angle within prism, from Snell' s law of refraction;

ε=d(tan(θ)−tan(θ′)) Difference between cone radii at the prism exit surface;

α1=ω1 csc(θ) Distance from prism position to focus in the absence of the prism;

α2=ω2 csc(θ) Distance from prism position to focus in the presence of the prism; and,

δ=α2−α1=(ω2−ω1) csc(θ)=εcsc(θ) Additional working distance

For cones of small convergence angle, this expression may be simplified further using a small angle approximation, sin(θ)≈θ:

ε≈dθ(1-1/n), and therefore

δ≈d(1−1/n).

Performance evaluations of the side-looking probe 100 have been performed. The side-looking probe 100 showed excellent performance in comparison to a conventional forward-looking probe, as shown in Table 1 below. Note that in Table 1 p-value is a measure of statistical correlation between the collected sample spectrum and a known reference spectrum. The p-value ranges in value from 0 to 1, with larger values indicating higher correlation

TABLE 1
Comparison of Performance Versus Conventional Probe

| | Conventional | | Extended Working | |
|---|---|---|---|---|
| | Probe | | Distance Probe | |
| | Properly | p- | Properly | p- |
| Sample Material | identified? | value | identified? | value |
| Sodium bicarbonate (powder) | Yes | 0.41 | Yes | 0.43 |
| Acetone (liquid in clear glass) | Yes | 0.49 | Yes | 0.48 |
| 2-Propanol (liquid in clear | Yes | 0.46 | Yes | 0.54 |
| glass) | | | | |
| Hexane (liquid in brown glass) | Yes | 0.47 | Yes | 0.49 |
| Cyclohexane (liquid in clear | Yes | 0.52 | Yes | 0.56 |
| glass) | | | | |
| Cyclohexane (liquid in plastic) | Yes | 0.52 | Yes | 0.51 |
| Cyclohexane (liquid in brown | Yes | 0.45 | Yes | 0.51 |
| glass) | | | | |

A variety of materials may be used for fabrication of the prism 110. Exemplary optical glass include fused silica (n≈1.4) and BK7, a borosilicate glass available from Schott of North America, Elmsford, N.Y. Other borosilicate glasses may be used, as well as other material such as sapphire (Al₂O₃). At least one layer of a hard coat or other optical material may be applied to the prism. Additional layers may provide for at least one of physical protection of the prism and optical enhancement.

In some embodiments, the side-looking probe 100 is incorporated into the fiber-optic assembly 27, and is not generally detachable. In other embodiments, the side-looking probe 100 includes a mount that provides for mounting over the forward-looking probe 50.

In some embodiments, the side-looking probe 100 is permanently attached to a fiber-optic assembly, which is in turn fixed within a spectrometer. In some instances, such embodiments offer lower cost of manufacture as well as improved optical signal strength.

Thus, disclosed herein is a spectrometer assembly comprising a spectrometer, an interface module, and a fiber optic assembly as well as a side-looking attachment, each connectable to and disconnectable from the spectrometer. In the event of contamination or damage to the fiber optic assembly, it can be easily withdrawn from the interface module and replaced. The interface module may similarly be separated from the spectrometer and the probe head assembly and replaced with a module containing a different arrangement of light manipulation devices.

There is still further provided a fiber optic assembly having, or in combination with, a lens which accepts diverging laser light exiting an excitation fiber and focuses the laser light on a limited area of a specimen under test, and which accepts diverging Raman signal light from the specimen and focuses the Raman light on a distal end of a collection fiber.

The above-described assembly may be used to obtain a Raman analysis in accordance with a method including the steps of providing the Raman spectrometer 22 having the laser light source and the Raman signal analyzer, providing the interface module 24 which is adapted for attachment to the spectrometer 22, the module 24 having therein light manipulating devices 28 for directing laser light and Raman signal light for effecting excitation of the specimen and collection and directing of Raman signal light to the Raman signal analyzer, and providing the fiber optic assembly 27 comprising the excitation fiber 44, the collection fiber 64, and one of the probe head 50 and the side-looking attachment 100, attaching the interface module 24 to the spectrometer 22, attaching the fiber optic assembly to the interface module 24, placing one of the probe head 50 and the side-looking attachment 100 adjacent the specimen S, and energizing the laser light source LS, whereby to cause laser light to pass from the spectrometer 22 to the interface module 24 and therein to be directed by the light manipulating devices 28 to the excitation fiber 44 and 21 of the probe head 50 and the side-looking attachment 100 and onto the specimen S, and thence Raman signal light back through the collection fiber 64 to the interface module 24 wherein the manipulating devices 28 direct the Raman signal light to the spectrometer Raman light analyzer LA.

The method may include the further step of providing the focusing lens 72 between the fiber distal ends 48, 66 and the specimen S, such that Raman signal light from the specimen is focused on the distal end 66 of the collection fiber 64.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A side-looking optical probe for a Raman spectroscopy system, the probe comprising:
a base for mounting the probe to an optical assembly of the system; and
a prism mounted to the base, the prism configured for receiving signal light from a sample and providing the signal light to the system.

2. The probe as in claim 1, wherein the prism comprises a right angle prism.

3. The probe as in claim 1, wherein the prism comprises an optical glass including a refractive index, n, that is at least 1.4.

4. The probe as in claim 1, wherein the prism comprises a hard coat disposed thereon.

5. The probe as in claim 1, further comprising at least another optical element.

6. The probe as in claim 5, wherein the optical element comprises a focusing lens.

7. The probe as in claim 1, wherein the prism is further configured for illuminating the sample.

8. The probe as in claim 1, wherein the base is adapted for clamping to the optical assembly.

9. The probe as in claim 1, wherein the base is configured with one of a snap-on, clamp-on, screw-on, slide-and-lock-on arrangement for mating with the optical assembly.

10. The probe as in claim 1, wherein the prism comprises sapphire.

11. The probe is in claim 1, wherein the prism comprises borosilicate glass.

12. The probe as in claim 1, wherein the prism comprises fused silica.

13. The probe as in claim 1, wherein the prism comprises an optical glass.

14. A method for fabricating a side-looking optical probe for a Raman spectroscopy system, the method comprising:
selecting a base for mounting the probe to an optical assembly of the system; and
mounting a prism to the base, the prism configured for receiving signal light from a sample and providing the signal light to the system.

15. The method as in claim 14, further comprising selecting a prism that includes at least one of sapphire, borosilicate glass, and fused silica.

16. The method as in claim 14, further comprising disposing a hard coat onto the prism.

17. The method as in claim 14, further comprising selecting a prism that exhibits a refractive index, n, that is at least 1.4.

18. The method as in claim 14, wherein the prism comprises an optical glass.

19. A Raman spectroscopy system, comprising:
a Raman spectrometer comprising a laser light source and a signal analyzer, the light source configured for illuminating a sample and the analyzer configured for analyzing signal light;
a fiber optic assembly configured for receiving light from the light source and receiving signal light from a sample; and
and a side-looking probe optically mounted to the fiber optic assembly, the side-looking probe comprising a prism configured for receiving signal light from the sample and providing the signal light to the spectrometer.

20. A method of using a Raman spectroscopy system, the method comprising:
selecting a Raman spectroscopy system that comprises a side-looking probe, the probe comprising a prism mounted to a fiber optic assembly, the prism configured for receiving signal light from a sample and providing the signal light to the system; and
analyzing a sample with the system.

21. The method as in claim 20, wherein the analyzing comprises at least one of illuminating the sample with light from the system and receiving signal light with the system.

22. The method as in claim 20, further comprising orienting the side-looking probe to provide a substantially side-looking measurement.
